(19) United States
(12) Patent Application Publication
(10) Pub. No.: US 2007/0281825 A1
(43) Pub. Date: Dec. 6, 2007

(54) Toroidal Gearbox With A Hydraulic Pressure Device

(75) Inventor: Steffen Henzler, Boebingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/578,190

(22) PCT Filed: Nov. 3, 2004
(86) PCT No.: PCT/EP04/12424

§ 371 Date: Mar. 1, 2007

(30) Foreign Application Priority Data
Nov. 5, 2003 (DE) 103 52 174.7

(51) Int. Cl. F16H 61/30; F16H 15/38

(52) U.S. Cl. 476/10; 476/40

(57) ABSTRACT

A toroidal gearbox in which an annular central disc with a toroidal friction surface and an annular main cylinder of a hydraulic pressure device are located concentrically to a central shaft. A radial partition wall is provided between the central disc and the main cylinder to form two working pressure chambers, the pressurization of which results in axial displacement of the central disc relative to the central shaft to apply contact pressure forces on the friction surface. A pressure piston between the partition wall and the main cylinder having an axial projection effectively bypasses the partition wall and acts on the central disc, in addition to the pressure applied in the pressure chamber between the partition wall and the central disk, thereby achieving an even distribution of the operating force in the circumferential direction, as exerted on the central disc, by the pressure piston.

This application is a national phase application of International application PCT/EP2004/012424 filed Nov. 3, 2004 and claims the priority of German application No. 103 52 174.7, filed Nov. 5, 2003, the disclosure of which are expressly incorporated by reference herein.

### BACKGROUND AND SUMMARY OF THE INVENTION

The present invention relates to a toroidal gearbox comprising a hydraulic pressure device.

A toroidal gearbox is known from WO 02/053945 A1, in which the main cylinder—which, on its end face facing the central disk is actually open and at its opposite end is closed by a radial end wall—accommodates merely the significant pressure piston and thus has only the associated working pressure chamber. In this known toroidal gearbox, the structurally separate partition wall is supported from the outside in a motionally fixed manner against the open front face of the main cylinder in the axial direction pointing from the central disk to the end wall. This partition wall is inserted in a pressure-resistant and axially displaceable manner, virtually in a configuration as a direct pressure piston, into a central frontal recess in the central disk, which recess in this case forms the other working pressure chamber belonging to this direct pressure piston. The significant pressure piston is provided on its front face facing the partition wall with three axial projections, which are evenly spaced in the peripheral direction and which respectively pass in a positive-locking manner and under a pressure-resistant seal through an associated cylindrical through-hole in the partition wall, such that they are axially displaceable. When the significant pressure piston is pressurized, these projections, which are respectively configured in the style of a pressure pin of solid cross section, bear with their free end faces directly against the radial end wall of that frontal recess in the central disk which forms the cylinder of the direct pressure piston and thereby act mechanically upon the central disk, in addition to the direct hydraulic actuation thereof by the direct pressure piston. This type of force transfer is disadvantageous inasmuch as the transmission of the piston force of the significant pressure piston into the central disk takes place only at discrete locations and therefore, under high loads, a wave-shaped deformation of the central disk occurs. As a result, locally increased stresses upon the central disk are initiated. Furthermore, the time pattern of the transmission, as a result of the ensuing irregularities of the rolling motion of the planet-like, yet non-circling intermediate friction wheels can likewise exhibit an irregularity. The production of the pressure-pin-like projections, especially when configured in one piece with their associated significant pressure piston, is complex. Owing to the function-conditioned sealing of the projections, a high positional accuracy of the same to one another is necessary. Given all this, the production of the projections is expensive.

The frontal engagement surface on the projection, of coaxial and annular configuration, of the significant pressure piston for the force transmission into the central disk can be configured to be broadly continuous, in particular fully continuous in the peripheral direction, so that an even force distribution in the peripheral direction is achieved. The pressure level which is necessary for a substantially slip -free pressing is low even at high torques, owing to the additional pressing function of the significant pressure piston.

The production of the significant pressure piston, even when configured in one piece with its frontal projection for the actuation of the central disk, is simplified, inter alia because this projection is configured coaxially to the piston axis. Thus, the production costs of toroidal gearboxes are also kept low.

In the toroidal gearbox according to an embodiment of the second invention, the drawback of the known toroidal gearbox of the generic type, (according to which the projection of the significant pressure piston is configured as an actuating means and enters into the non-associated working pressure chamber of the direct pressure piston) is avoided, so that the seals which, in the known toroidal gearbox, are necessary for this ventilation are omitted in the toroidal gearbox.

In the toroidal gearbox according to another embodiment of the invention, a depressurization of the piston rear side of the annular significant pressure piston is facilitated by guiding of the coaxial projection of the piston in a pressure-resistant manner in the central opening in the partition wall, for the separation of atmospheric pressure and working pressure.

In one embodiment of the toroidal gearbox according to the invention, the axial dimension of the pressure device is kept low by the significant pressure piston having a concentric cylindrical outer face, which is guided in a pressure-resistant and axially displaceable manner in a corresponding cylindrical innerface of the partition wall.

In further advantageous embodiments of the toroidal gearbox according to the invention, the size of the effective piston cross section of the direct pressure piston can be optimized by a direct pressure piston which actuates the central disk and is guided directly against a corresponding inner shell of the main cylinder, or a direct pressure piston which cooperates via a ring seal in a peripheral groove against a corresponding inner shell, or which cooperates via a ring seal and groove in the corresponding inner shell of the main cylinder.

In a further advantageous embodiment of the toroidal gearbox according to the invention, the pressure supply to the two working pressure chambers can be simplified with the procurement of an axial annular gap pressure which emerges at one end in the working chamber of the direct pressure piston and at the other end in the working pressure chamber of the significant pressure piston.

In an advantageous development, the dimension of the effective piston surface of the significant pressure piston can be optimized for pressure-tight, displaceable fit against the cylindrical inner face of the main cylinder.

In the known toroidal gearbox of the generic type, the central openings in all the annular components of the pressure device, such as main cylinder, significant pressure piston, partition wall with direct pressure piston and central disk with frontal recess as the working pressure chamber of the direct pressure piston, are respectively passed through, in a direct and pressure-resistant manner, by the central shaft, which in this case is the output shaft of the toroidal gearbox. The pressure device of this known toroidal gearbox cannot therefore form a preassemblable gearbox module, owing to the structurally separate assignment of its components to the central shaft.

In embodiments of the toroidal gearbox according to the invention, the pressure device can be advantageously configured both with respect to its axial dimension and for the purpose of a preassemblable module, by the arrangement of a detachably inserted partition wall which can be axially supported against an axial counter-bearing of the main cylinder.

As a counter-bearing for its support, in this arrangement of the partition wall, an innerface of the radial end wall of the main cylinder which delimits the working pressure chamber of the significant pressure chamber can be provided.

In an advantageous alternative embodiment of the toroidal gearbox according to the invention, a hub of the main cylinder having a diameter offset and having a central opening for the main shaft can serve as the counter-bearing for the support of the partition wall detachably inserted in the main cylinder.

Refinements of the toroidal gearbox according to the invention with respect to the support of the partition wall in the opposite axial direction, pointing from the end wall of the main cylinder to the central disk, against a locking ring inserted in a peripheral groove in the main cylinder and with respect to the guidance of the direct pressure piston, which directly actuates the central disk, with a cylindrical inner shell against a corresponding outer shell of the main cylinder, serve in particular also for the advantageous configuration of the pressure device as a preassemblable gearbox module.

Further embodiments relate to advantageous features of a depressurization of the rear side of the significant pressure piston, focusing upon the use of a passive pressure chamber, ventilated to the atmosphere, and an advantageous specific development of a ventilation connection, communicating with this pressure chamber, in the toroidal gearbox.

In the known toroidal gearbox of the generic type, the central disk is connected in a rotationally secure manner to the central shaft directly by corresponding axial drive toothings, the radially outer one of which is incorporated in the central opening in the central disk and the radially inner one of which is incorporated in the cylindrical outer casing of the central shaft. Owing to the, in relation to the external dimensions of the gearbox, very small effective radius on which torque is transferred from the central disk via the drive toothings to the central shaft, the surface pressings against the toothings are high and thereby conditioned consequential damage is considerable.

In in the toroidal gearbox according to the invention, these aforementioned drawbacks are avoided by virtue of drive toothings which are disposed not in the region of the inner periphery, but in the region of the outer periphery of the central disk.

Whereas, in the known toroidal gearbox of the generic type, the direct pressure piston is formed by a specific development of the partition wall, this pressure piston, in the toroidal gearbox according to the invention, can be arranged either structurally alone and motionally fixed relative to the central disk, or structurally integrated by virtue of configuring the direct pressure piston and the central disk in one piece.

Since, in the known toroidal gearbox of the generic type, which is designed according to the 2-chamber principle, the two input-side central disks situated in the axially central gearbox region are drive-connected by an intervening offset gearbox in the form of a continuously variable transmission having an input shaft disposed parallel to the output shaft, in this gearbox the pressure supply unit for the pressure device, which latter is supplied via an inner, longitudinally running pressure duct of the central shaft, must be housed in a gearbox region situated axially outside the actual gearbox components, whereby the structural length of the total gearbox is naturally enlarged.

In a toroidal gearbox according to another embodiment of the invention, the structural length of the total gearbox is not enlarged by the arrangement of the pressure supply unit, since the latter is housed in a central housing interior of the gearbox housing, which housing interior adjoins the toroidal friction surface of the central disk, and is connected to the inner pressure duct of the central shaft. This connection point can be configured as a stationary, in particular hydrodynamic shaft bearing for the radial support of the central shaft against the gearbox housing.

In the toroidal gearbox according to the prior art forming the generic type, axially resilient means are used to generate a basic contact pressure against the toroidal friction surface of the central disk, which is configured in the form of a cup spring which is disposed in the working pressure chamber of the significant pressure piston and is supported directly against the end wall of the main cylinder and acts directly upon the significant pressure piston for the purpose of an actuation of the central disk.

By contrast, the resilient elements for generating the basic contact pressure in the toroidal gearbox according to a further embodiment of the invention are supported, via the radial partition wall, indirectly against the main cylinder.

In a development of the foregoing embodiment of the toroidal gearbox, the axial dimension of the pressure device can be shortened, for example, by the fact that the resilient elements for generating the basic contact pressure are inserted in the passive pressure chamber, which is provided between the significant pressure piston and the radial partition wall.

In a further advantageous embodiment of the toroidal gearbox according to the invention, a particular support of the partition wall against the main cylinder in the axial direction pointing from the end wall of the main cylinder to the central disk can be omitted by virtue of the fact that the resilient elements for generating the basic contact pressure are disposed in the working pressure chamber of the direct pressure piston.

In the known toroidal gearbox forming the generic type, a possible of an arrangement with resilient elements supported via the radial partition wall, indirectly against the main cylinder, in an embodiment with the resilient elements between the significant pressure piston, and the radial partition wall, would cause the resilient elements for generating the basic contact pressure to be supported, on the one hand, directly against the partition wall used as a direct pressure piston and, on the other hand, to act directly upon the central disk.

In application of the foregoing resilient element arrangements in a toroidal gearbox according to the invention, the resilient elements for generating the basic contact pressure act upon the central disk indirectly via the direct pressure piston.

Other objects, advantages and novel features of the present invention will become apparent from the following detailed description of the invention when considered in conjunction with the accompanying drawings for example.

### BRIEF DESCRIPTION OF THE DRAWINGS

FIG. 1 illustrates a partial longitudinal section through a first embodiment of a toroidal gearbox according to the present invention, in which also an embodiment of a pressure supply to the pressure device of the toroidal gearbox is employed,

FIG. 1a illustrates a partial longitudinal section through a second embodiment of a toroidal gearbox according to the present invention, in which also an arrangement of resilient elements for generating a basic contact pressure against a toroidal friction surface of a central disk of the toroidal gearbox is employed, and

FIG. 2 illustrates a partial longitudinal section through another embodiment of a toroidal gearbox according to the present invention.

### DETAILED DESCRIPTION

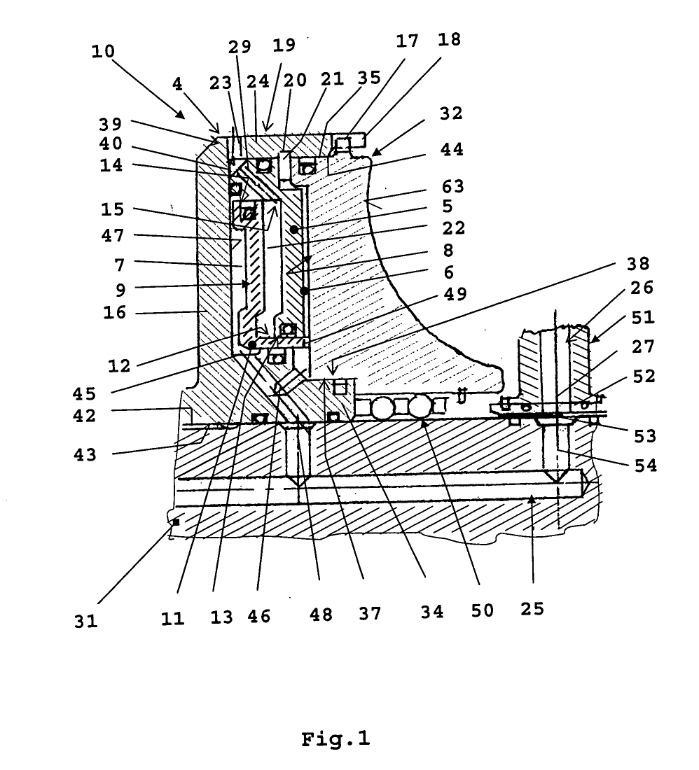

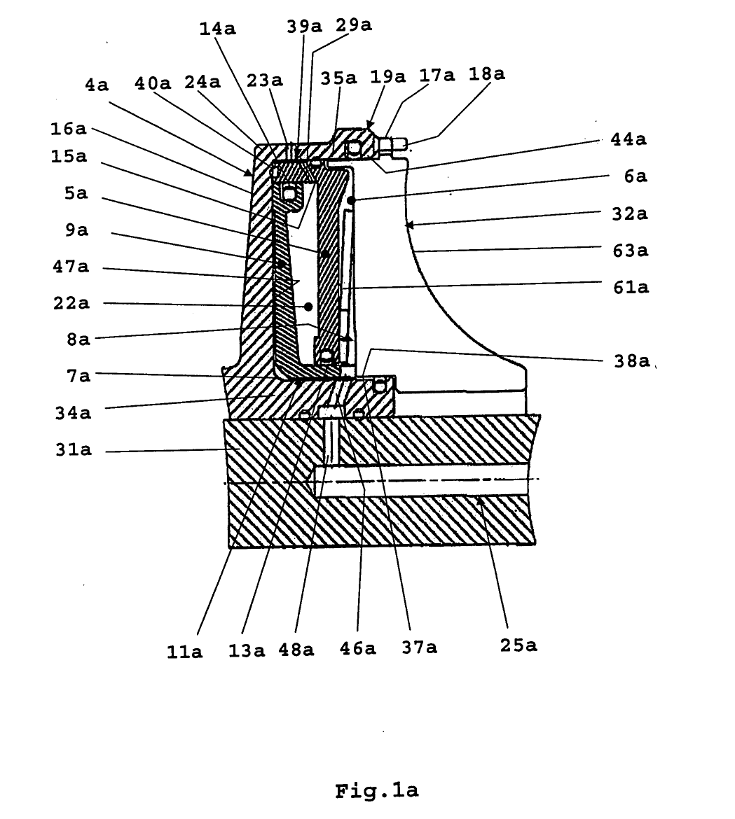

With reference initially to the first embodiment of the first invention in FIG. 1, on a central shaft 31 of a toroidal gearbox (which in this embodiment forms the input shaft drivable by a drive unit) there are concentrically disposed an annular main cylinder 4 of U-shaped cross section of a hydraulic pressure device 10, and an annular central disk 32 having a toroidal friction surface 63. The main cylinder 4 has, for its mounting on the central shaft 31, a hub 34 configured in one piece therewith, which hub is connected in a rotationally secure manner to the central shaft 31 by corresponding axial drive toothings 42, 43.

In the main cylinder 4 there is detachably inserted a radial partition wall 5, which, in the axial direction pointing from the central disk 32 to the radial end wall 16 of the main cylinder 4, is supported against the inner face 47 of this end wall 16 and, in the opposite axial direction, is supported against a locking ring 21 inserted in a peripheral groove 20 made in the cylindrical inner shell 44 of the main cylinder 4.

On that side of the partition wall 5 facing the central disk 32, an annular pressure piston 8 is provided, which, with the partition wall 5, encloses an associated working pressure chamber 6 and is configured in one piece with the central disk 32—in the axial direction pointing from the end wall 16 to the partition wall 5, thus directly actuates this central disk 32, arranged in an axially displaceable manner relative to the central shaft 31, so that contact pressures can be brought to bear upon the toroidal friction surface 63. The direct pressure piston 8 is guided with its cylindrical outer shell 35 against the inner shell 44 of the main cylinder 4 and with its cylindrical inner shell 37 against a corresponding outer shell 38 of the hub 34, respectively in a pressure-resistant and axially displaceable manner.

On that side of the partition wall 5 facing away from the central disk 32, a significant annular pressure piston 9 is provided, which, with the end wall 16, encloses an associated working pressure chamber 7 and, with its cylindrical outer shell 14, is guided in a pressure-resistant and axially displaceable manner against a corresponding inner shell 15 of the partition wall 5. On its radially inner peripheral region, the significant pressure piston 9 has a coaxial annular projection 11, which passes through the central opening 13 in the partition wall 5 and, when pressurized, comes to bear with its free end face against the direct pressure piston 8 and thus additionally actuates the central disk 32.

The working pressure chambers 6 and 7 are connected by communicating pressure ducts 45 and 46 in the hub 34 and by radial pressure ducts 48 of the central shaft 31 to a longitudinally running inner pressure duct 25 of the central shaft 31. The projection 11 of the significant pressure piston 9 can have on its free end face a recess 49 or a few such recesses in order to ensure a constantly open connection between the working pressure chamber 6 and the pressure ducts 45, 46.

In order to create a passive pressure chamber 22 for the depressurization of the piston rear side of the significant pressure piston 9, the projection 11 is guided with its cylindrical outer casing 12, in a pressure-resistant manner, against the corresponding inner casing of the central opening 13, and the pressure chamber 22 is connected by a ventilation connection 39 to a ventilated region, situated outside the main cylinder 4, of a housing interior of the gearbox housing. This ventilation connection 39 contains an annular duct 40, which is created by a bevel on the outer periphery of the partition wall 5 in the region of the end wall 16 and is sealed by ring seals against the working pressure chambers 6 and 7. The annular duct 40 is connected by a ventilation duct 29 of the partition wall 5 to the pressure chamber 22 and by a ventilation port 23, provided in the adjacent wall portion 24 of the cylindrical outer wall 19 of the main cylinder 4, to said ventilated region of a housing interior.

For the indirect rotationally secure connection to the central shaft 31, the central disk 32 has on its outer periphery an axial drive toothing 17, which engages in a rotationally secure manner in a corresponding axial drive toothing 18 on the free end face of the outer wall 19 of the main cylinder 4.

Between the central disk 32 and the central shaft 31, a linear rolling element guide 50 can be inserted, which, in this embodiment, is fixed in the axial direction pointing from the central disk 32 to the end wall 16 by the hub 34 and in the opposite axial direction by a locking ring inserted in an inner peripheral groove in the central disk 32.

The main cylinder 4 can be rigidly supported against the central shaft 31, in the axial direction pointing from the central disk 32 to the end wall 16, by an axial counter-bearing, in a manner which is not further represented.

In that region of the housing interior of the gearbox housing which adjoins the toroidal friction surface 63 there is disposed a bearing arm 51, which is Notionally fixed relative to the gearbox housing and which holds at its one end a bearing sleeve 52, surrounding the central shaft 31, of a hydrodynamic bearing, by which the central shaft 31 is radially supported against the gearbox housing.

Integrated in the bearing arm 51 is a pressure line 26, which, in dependence on a connected pressure control unit of the toroidal gearbox, can be subjected to an, in particular, torque-dependent and transmission-dependent working pressure. By means of the bearing sleeve 52, the line end 27 of the pressure line 26 is brought into overlap with a peripheral groove 53 in the central shaft 31, which, for its part, is connected by at least one radial connecting bore 54 to the pressure duct 25 of the central shaft 31, so that the working pressure chambers 6 and 7 are connected to the pressure line 26.

In the toroidal gearbox in the second embodiment of the invention in figure la, on a central shaft 31a of a toroidal gearbox (which in this embodiment, too, forms the input shaft drivable by a drive unit) there are concentrically disposed an annular main cylinder 4a of U-shaped cross section of a hydraulic pressure device, and an annular central disk 32a having a toroidal friction surface 63a. The main cylinder 4a has, for its mounting on the central shaft 31a, a hub 34a configured in one piece therewith, which hub is connected in a motionally fixed manner to the central shaft 31a.

In the main cylinder 4a there is detachably inserted a radial partition wall 5a, which, in the axial direction pointing from the central disk 32a to the radial end wall 16a of the main cylinder 4a, is supported against the inner face 47a of this end wall 16a.

On that side of the partition wall 5a facing the central disk 32a, an annular pressure piston 8a is provided, which, with the partition wall 5a, encloses an associated working pressure chamber 6a and is configured in one piece with the central disk 32a—in the axial direction pointing from the end wall 16a to the partition wall 5a, thus directly actuates this central disk 32a, arranged in an axially displaceable manner relative to the central shaft 31a, so that contact pressures can be brought to bear upon the toroidal friction surface 63a. The direct pressure piston 8a is guided with its cylindrical outer shell 35a against the inner shell 44a of the main cylinder 4a and with its cylindrical inner shell 37a against a corresponding outer shell 38a of the hub 34a, respectively in a pressure-resistant and axially displaceable manner.

On that side of the partition wall 5a facing away from the central disk 32a, a significant annular pressure piston 9a is provided, which, with the end wall 16a, encloses an associated working pressure chamber 7a and, with its cylindrical outer shell 14a, is guided in a pressure-resistant and axially displaceable manner against a corresponding inner shell 15a of the partition wall 5a. On its radially inner peripheral region, the significant pressure piston 9a has a coaxial annular projection 11a, which passes through the central opening 13a in the partition wall 5a and, when pressurized, comes to bear with its free end face against the direct pressure piston 8a and thus additionally actuates the central disk 32a.

The working pressure chambers 6a and 7a are connected one to another by an open axial annular gap between the projection 11a and the hub 34a and to a longitudinally running inner pressure duct 25a of the central shaft 31a by radial pressure ducts 46a in the hub 34a, and by communicating radial pressure ducts 48a of the central shaft 31a.

The projection 11a of the significant pressure piston 9a can have on its free end face a recess or a few such recesses in order to ensure a constantly open connection between the working pressure chamber 6a and the pressure ducts 46a.

In order to create a passive pressure chamber 22a for the depressurization of the piston rear side of the significant pressure piston 9a, the projection 11a is guided with its cylindrical outer casing, in a pressure-resistant manner, against the corresponding inner casing of the central opening 13a, and the pressure chamber 22a is connected by a ventilation connection 39a to a ventilated region, situated outside the main cylinder 4a, of a housing interior of the gearbox housing. This ventilation connection 39a contains an annular duct 40a, which is created by a narrowed offset on the outer periphery of the partition wall 5a in the region of the end wall 16a and is sealed by ring seals against the working pressure chambers 6a and 7a. The annular duct 40a is connected by a ventilation duct 29a of the partition wall 5a to the pressure chamber 22a and by a ventilation port 23a, provided in the adjacent wall portion 24a of the cylindrical outer wall 19a of the main cylinder 4a, to said ventilated region of a housing interior.

For the indirect rotationally secure connection to the central shaft 31a, the central disk 32a has on its outer periphery an axial drive toothing 17a, which engages in a rotationally secure manner in a corresponding axial drive toothing 18a on the free end face of the outer wall 19a of the main cylinder 4a.

As in the first embodiment of FIG. 1, a linear rolling element guide (not represented here) can be inserted between the central disk 32a and the central shaft 31a.

The main cylinder 4a can be rigidly supported against the central shaft 31a, in the axial direction pointing from the central disk 32a to the end wall 16a, by an axial counter-bearing, in a manner which is likewise not further represented.

Provided in the working pressure chamber 6a is a cup spring 61a for generating a basic contact pressure against the toroidal friction surface 63a, which, in the axial direction pointing from the central disk 32a to the end wall 16a, is supported with its radially inner marginal region against the partition wall 5a and, in the opposite direction, acts with its radially outer marginal region, via the direct pressure piston 8a, upon the central disk 32a.

In this way, the advantage is additionally achieved that the partition wall 5a does not continue to have to be separately supported against the main cylinder 4a—for example by means of a locking ring—in the axial direction pointing from the end wall 16a to the central disk 32a.

The omission of an inner peripheral groove in the main cylinder for a locking ring allows the external diameter of the significant pressure piston 9a, and thus the effective pressure surface thereof, to be enlarged compared to the first embodiment of FIG. 1.

This is also abetted by the radially outward shifted arrangement of the seal acting between the corresponding cylindrical surfaces 35a and 44a of the direct pressure piston 8a and the main cylinder 4a, which seal is inserted in an inner peripheral groove in the outer wall 19a.

Since the working pressure chambers 6a and 7a are openly connected to each other by the axial annular gap between the projection 11a and the hub 34a, it is sufficient for the supply of pressure, for example in the manner envisaged in the first embodiment of FIG. 1 via a pressure line 26 connected to the central pressure duct 25a of the central shaft 31a, to connect only one of these two working pressure chambers—via radial bores 46a in the hub 34a—to the pressure duct 25a. Hence, a special seal between the projection 11a of the significant pressure piston 9a and the hub 34a of the main cylinder 4a is unnecessary.

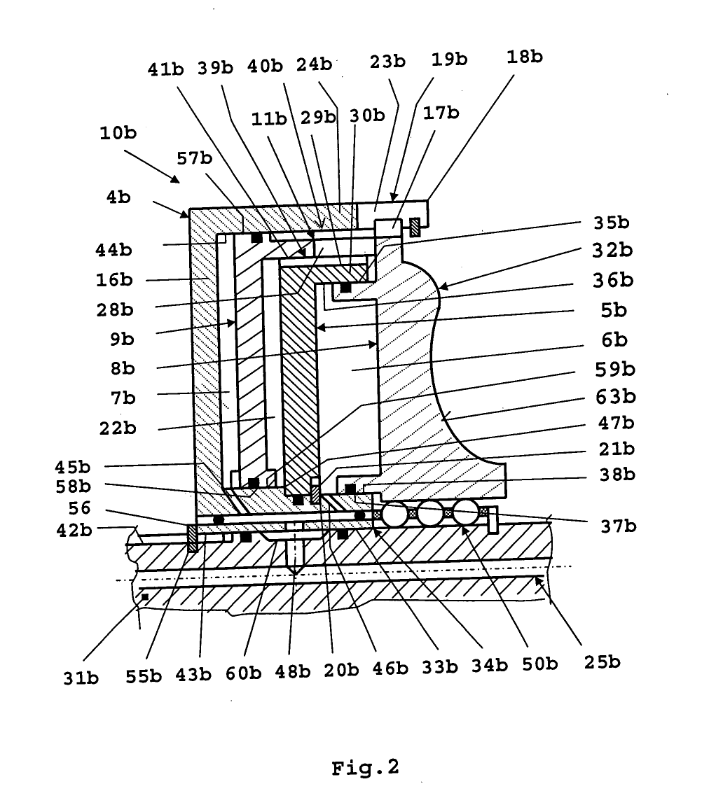

With reference now to a further embodiment of the toroidal gear according to the invention, in FIG. 2 on a central shaft 31b of the toroidal gearbox (which constitutes the input shaft) there are once again concentrically disposed an annular main cylinder 4b of U-shaped cross section of a hydraulic pressure device 10b, and an annular central disk 32b having a toroidal friction surface 63b.

The main cylinder 4b can be rigidly supported against the central shaft 31b, in the axial direction pointing from the central disk 32b to the radial end wall 16b of the main cylinder 4b, by a locking ring 56 inserted in a peripheral groove 55b in the central shaft 31b.

The main cylinder 4b is connected to the central shaft 31b in a rotationally secure manner, via its radially inner hub 34b the central opening 33b of which is passed through in a positive-locking manner by the central shaft 31b, by corresponding axial drive toothings 42b, 43b.

For the indirect rotationally secure connection to the central shaft 31b, the central disk 32b has on its outer periphery an axial drive toothing 17b, which engages in a rotationally secure manner in a corresponding drive toothing 18b in the cylindrical outer wall 19b of the main cylinder 4b.

In the main cylinder 4b there is inserted a radial partition wall 5b, which, in the axial direction pointing from the central disk 32b to the radial end wall 16b of the main cylinder 4b, is supported against an axial counter-bearing in the form of a diameter offset 47b of the hub 34b of the main cylinder 4b. The partition wall 5b is supported, in the opposite axial direction, against a locking ring 21b inserted in a peripheral groove 20b in the hub 34b.

The central disk 32b is configured in one piece with a direct pressure piston 8b, which is thus situated on that side of the partition wall 5b facing the central disk 32b and acts directly upon the central disk 32b.

The partition wall 5b, which is sealed in a pressure-resistant manner against the hub 34b, has on its radially outer region a cylinder 30b, which, together with the hub 34b and the direct pressure piston 8b, encloses a working pressure chamber 6b belonging to the latter. In this case, the direct pressure piston 8b is guided with an outer cylindrical piston surface 35b against the corresponding inner face 36b of the cylinder 30b and with an inner cylindrical piston surface 37b against a corresponding outer narrow hub surface 38b of the hub 34b, respectively in a pressure-resistant and axially displaceable manner.

The main cylinder 4b has an annular significant pressure piston 9b disposed between its end wall 16b and the partition wall 5b, which with its outer cylindrical piston surface 57b is guided against the corresponding inner face 44b of the main cylinder 4b and with its inner cylindrical piston surface 58b is guided against the corresponding outer wide hub surface 59b of the hub 34b, respectively in a pressure-resistant and axially displaceable manner.

In this way, the significant pressure piston 9b and the end wall 16b of the main cylinder 4b enclose a working pressure chamber 7b belonging to this pressure piston.

The working pressure chambers 6b and 7b are connected by a respective pressure duct 46b and 45b, and herewith communicating further pressure ducts in the hub 34b of the main cylinder 4b, to a peripheral groove 60b in the central shaft 31b, which communicates by at least one radial bore 48b with a longitudinally running inner pressure duct 25b of the central shaft 31b. The pressure duct 25b can be subjected, for example in the manner described in connection with the toroidal gearbox of FIG. 1, to an, in particular, torque-dependent and transmission-dependent working pressure.

On its front face facing the partition wall 5b, the significant pressure piston 9b has a coaxial annular projection 11b, which is configured for the actuation of the central disk 32b and is disposed in the annular space 40b enclosed by the cylindrical wall 19b of the main cylinder 4b and the cylinder 30b of the partition wall 5b and which, when pressurized, comes to bear with its free end face against the central disk 32b.

In order to relieve the piston rear side of the pressure piston 9b, this pressure piston and the partition wall 5b enclose a passive pressure chamber 22b, which is connected by a ventilation connection 39b to a ventilated region of a housing interior of the gearbox housing.

The ventilation connection 39b contains a ventilation duct in the form of a longitudinal groove 29b in the outer casing 41b of the cylinder 30b, which longitudinal groove, on the one hand, emerges in the pressure chamber 22b and, on the other hand, communicates via a ventilation passage 28b in the projection 11b of the significant pressure piston 9b with a ventilation connection 23b, which is provided in that wall portion 24b of the cylinder wall 19b enclosing the annular space 40b and which is openly connected to the ventilated region of the housing interior.

In place of the longitudinal groove 29b, an axial bore may also be provided in the wall portion 30b.

Finally, in this toroidal gearbox also, between the central shaft 31b and the central shaft 32b it is possible to insert a linear rolling element guide 50b, which, in this embodiment, is fixed in the axial direction pointing from the central disk 32b to the end wall 16b by the hub 34b and in the opposite axial direction by a locking ring inserted in an inner peripheral groove in the central shaft 31b.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-26. (canceled)

27. A toroidal gearbox, comprising:
a central shaft;
an annular main cylinder disposed on the central shaft in a concentric and rotationally- and axially-secure manner;
an annular central disk disposed on the main cylinder in a concentric, rotationally-secure and axially-movable manner, the central disk having a toroidal friction surface facing away from the main cylinder;
a radial partition wall disposed between the main cylinder and the central disk to form a first working pressure chamber between the partition wall and the central disk which, when pressurized, urges the central disk toroidal friction surface axially away from the main cylinder; and
a significant pressure piston disposed in a concentric and axially-movable manner between the partition wall and the main cylinder to form a second working pressure chamber between the pressure piston and the main cylinder, the pressure piston having projections extending toward the partition wall, said projections arranged to act upon the central disk and urge the central disk toroidal friction surface axially away from the main cylinder when the second working pressure chamber is pressurized.

28. The toroidal gearbox as claimed in claim 27, wherein the pressure piston projections are guided in a pressure-resistant manner through their corresponding openings in the partition wall.

29. The toroidal gearbox as claimed in claim 27, wherein the pressure piston has a concentric cylindrical radial outer face which is guided in a pressure-resistant and axially-displaceable manner in a corresponding cylindrical radial inner face of the partition wall.

30. The toroidal gearbox as claimed in claim 29, wherein a cylindrical outer shell of the central disk is guided in a pressure-resistant manner directly against a corresponding inner shell of the main cylinder.

31. The toroidal gearbox as claimed in patent claim 30, wherein the central disk cooperates via a ring seal, inserted in a peripheral groove in the central disk cylindrical outer shell, with the corresponding inner shell of the main cylinder.

32. The toroidal gearbox as claimed in claim 30, wherein the central disk cylindrical outer shell cooperates with a ring seal inserted in an inner peripheral groove in the corresponding inner shell of the main cylinder.

33. The toroidal gearbox as claimed in claim 27, wherein between the pressure piston projections and a hub of the main cylinder, there is provided an axially extending concentric annular gap, which at one end is open to the first working pressure chamber and at an opposite end is open to the second working pressure chamber.

34. A toroidal gearbox, comprising:
a central shaft;
an annular central disk disposed on the central shaft in a concentric and rotationally-secure manner, the central disk having a toroidal friction surface facing away from the main cylinder;
an annular main cylinder disposed on the central disk in a concentric, rotationally-secure manner, and disposed about the central shaft in an axially-nonmovable manner;
a radial partition wall disposed between the main cylinder and the central disk to form a first working pressure chamber between the partition wall and the central disk which, when pressurized, urges the central disk toroidal friction surface axially away from the main cylinder; and
a significant pressure piston disposed in a concentric and axially-movable manner between the partition wall and the main cylinder to form a second working pressure chamber between the pressure piston and the main cylinder, the pressure piston having projections extending toward the partition wall, said projections arranged radially outward of the partition wall to act upon the central disk and urge the central disk toroidal friction surface axially away from the main cylinder when the second working pressure chamber is pressurized.

35. The toroidal gearbox as claimed in claim 34, wherein the pressure piston, at its outer periphery, is guided in a pressure-tight and displaceable manner directly against a cylindrical radially inner surface of the main cylinder.

36. The toroidal gearbox as claimed in claim 27, wherein the partition wall is detachably inserted in the main cylinder and, in the axial direction is arranged to be axially supported against an axial counter-bearing surface of the main cylinder.

37. The toroidal gearbox as claimed in claim 34, wherein the partition wall is detachably inserted in the main cylinder and, in the axial direction is arranged to be axially supported against an axial counter-bearing surface of the main cylinder.

38. The toroidal gearbox as claimed in claim 36, wherein the counter-bearing for the partition wall is an inner face of a radial end wall of the main cylinder which delimits one side of the second working pressure chamber.

39. The toroidal gearbox as claimed in claim 37, wherein the counter-bearing for the partition wall is a diameter offset of a hub of the main cylinder.

40. The toroidal gearbox as claimed in claim 36, wherein the partition wall is supported in the axial direction against a locking ring inserted in a peripheral groove in the main cylinder.

41. The toroidal gearbox as claimed in claim 34, wherein the central disk is guided with a cylindrical radially outer shell surface in a pressure-resistant and displaceable manner against a corresponding radially inner shell surface of the partition wall.

42. The toroidal gearbox as claimed in claim 27, wherein the central disk is guided with a cylindrical radially inner shell in a pressure-resistant and displaceable manner against a corresponding radially outer shell of the main cylinder.

43. The toroidal gearbox as claimed in claim 27, wherein the central disk is guided with a cylindrical radially inner shell in a pressure-resistant and displaceable manner against a corresponding radially outer shell of the partition wall.

44. The toroidal gearbox as claimed in claim 27, wherein a ventilation connection is connected to a passive pressure chamber of the main cylinder enclosed by the significant pressure piston and the partition wall, said ventilation connection being passive with respect to actuation of the central disk and communicating with a region outside the main cylinder.

45. The toroidal gearbox as claimed in claim 44, wherein in the ventilation connection a ventilation port is provided in an outer wall portion of the main cylinder and connects the region outside the main cylinder with a ventilated region inside the main cylinder.

46. The toroidal gearbox as claimed in claim 44, wherein the ventilation connection contains a ventilation duct of the partition wall which is interposed between the passive pressure chamber and the ventilated region inside the main cylinder.

47. The toroidal gearbox as claimed in patent claim 46, wherein the ventilation duct of the partition wall is a longitudinal groove on a cylindrical radially outer casing of the partition wall.

48. The toroidal gearbox as claimed in claim 27, wherein the central disk has on its radially outer periphery axial drive teeth which engage in a rotationally secure manner in corresponding axial drive teeth in the cylindrical radially outer wall of the main cylinder.

49. The toroidal gearbox as claimed in claim 27, wherein the central disk includes a direct pressure piston surface on a side of the central disk facing the partition wall.

50. A toroidal gearbox, comprising:
a central shaft;
an annular central disk disposed on the main cylinder in a concentric, rotationally-secure and axially-movable manner, the central disk having a toroidal friction surface facing away from the main cylinder;
an annular cylinder-axial piston servo disposed on the central shaft in a concentric manner; and
a pressure line arranged in a Notionally fixed manner adjacent to the toroidal friction surface,
wherein
the central shaft has a longitudinally running inner pressure duct which is in fluid connection with the servo unit,
pressurization of the piston servo urges the central disk toroidal friction surface axially away from the piston servo, and
the pressure line is connected by a line end to supply working pressure controlled by a pressure control unit to the piston servo via the inner pressure duct of the central shaft.

51. A toroidal gearbox, comprising:
a central shaft;
an annular central disk disposed on the central shaft in a concentric and rotationally-secure manner, the central disk having a toroidal friction surface facing away from the main cylinder;
an annular main cylinder disposed on the central disk in a concentric, rotationally-secure manner, and disposed about the central shaft in an axially-nonmovable manner;
a radial partition wall disposed between the main cylinder and the central disk to form a first working pressure chamber between the partition wall and the central disk which, when pressurized, urges the central disk toroidal friction surface axially away from the main cylinder; and
at least one axially-resilient element disposed between the partition wall and the central disk and arranged to act upon the central disk to urge the central disk toroidal friction surface axially away from the main cylinder, said at least one axially-resilient element being supported indirectly via the partition wall against the main cylinder.

52. The toroidal gearbox as claimed in claim 51, wherein the at least one resilient element is disposed in the first working pressure chamber.

53. The toroidal gearbox as claimed in claim 52, wherein the at least one resilient element acta indirectly upon the central disk via a direct pressure piston which directly actuates the central disk.
